(19) United States
(12) Patent Application Publication
(10) Pub. No.: US 2011/0122346 A1
(43) Pub. Date: May 26, 2011

(54) LAMINATED-TYPE DISPLAY DEVICE

(75) Inventors: Masaki NOSE, Kawasaki (JP); Hirokazu Aritake, Kawasaki (JP)

(73) Assignee: FUJITSU LIMITED, Kawasaki-shi (JP)

(21) Appl. No.: 12/953,097

(22) Filed: Nov. 23, 2010

(30) Foreign Application Priority Data
Nov. 25, 2009 (JP) 2009-267936

(51) Int. Cl. G02F 1/1335

(52) U.S. Cl. 349/106

(57) ABSTRACT

There is provided a laminated type display device that includes a plurality of display elements. Each of the plurality of the display elements is configured to reflect respective colors and each of the respective colors is different from each other. Each of the plurality of the display elements includes respective transparent electrodes of which spectral characteristics are different each other.

### CROSS-REFERENCE TO RELATED APPLICATION

This application is based upon and claims the benefit of priority of the prior Japanese Patent Application No. 2009-267936, filed on Nov. 25, 2009, the entire contents of which are incorporated herein by reference.

### FIELD

The present invention relates to a laminated-type display device.

### BACKGROUND

Electronic paper is extensively developed in various companies, universities, etc. in recent years. Various forms of applications are proposed for application fields in which electronic paper is expected to be used, such as electronic books first on the list, sub-displays of mobile terminal devices, display units of IC cards, etc. One of leading technologies for electronic paper is cholesteric liquid crystal. The cholesteric liquid crystal has excellent features such as semi-permanent storage of displayed image (memory characteristic), vivid color display, high contrast and high-resolution characteristics.

The cholesteric liquid crystal is sometimes called chiral nematic liquid crystal, in which an additive of a chiral characteristic is added to nematic liquid crystal relatively much (several tens of percent) so that molecules of the nematic liquid crystal form a helical cholesteric phase. A cholesteric liquid crystal display device displays an image on a screen by using an orientation state of the liquid crystal molecules.

FIGS. 12A and 12B illustrate a state of the cholesteric liquid crystal. As illustrated in FIGS. 12A and 12B, a display element using the cholesteric liquid crystal has an upper substrate 110, a cholesteric liquid crystal layer 120, and a lower substrate 130. The cholesteric liquid crystal has two states. One is a planar state in which incident light is reflected as illustrated in FIG. 12A and the other is a focal conic state in which incident light passes as illustrated in FIG. 12B. These states are steadily maintained even if no electric field is applied.

In the planar state, the display element reflects light of a wavelength corresponding to a helical pitch of the liquid crystal molecules. A wavelength λ which maximizes the reflection is represented by an average refractive index n of the liquid crystal and the helical pitch p as follows:

λ=n×p

Meanwhile, a reflection bandwidth Δλ changes much depending upon refractive index anisotropy Δn of the liquid crystal.

The display element reflects incident light in the planar state and may thereby display white in a “light” state. Meanwhile, the display element provided with a light absorbing layer below the lower substrate 13 absorbs light having passed the liquid crystal layer, and may thereby display black in a “dark” state.

Then, a method for driving the display element using the cholesteric liquid crystal will be explained. If a specific high voltage (e.g., ±36 volts) is applied between electrodes to generate a relatively strong electric field in the cholesteric liquid crystal, the helical structures of the liquid crystal molecules completely disappear resulting in that all the molecules are oriented in the direction of the electric field in a homeotropic state. Then, if the applied voltage is abruptly changed downwards from the high voltage to a specific low voltage (e.g., within ±4 volts) to make the electric field abruptly about zero in the homeotropic state of the liquid crystal molecules, the liquid crystal enters into the planar state in which the helical axes of the liquid crystal are perpendicular to the electrodes and the light corresponding to the helical pitch is selectively reflected.

Meanwhile, if a specific low voltage (e.g., ±24 volts) is applied between the electrodes to generate a relatively weak electric field the cholesteric liquid crystal, the helical structures of the liquid crystal molecules do not completely disappear and some of them remain. If, in this state, the applied voltage is abruptly changed downwards and the electric field is abruptly made about zero, or if a strong electric field is applied and then the electric field is slowly removed, the liquid crystal enters into the focal conic state in which the helical axes of the liquid crystal molecules are parallel to the electrodes and the incident light passes. Further, if an electric field of middle strength is applied and then the electric field is abruptly removed, the planar state and the focal conic state are mixed so that a halftone display is enabled.

A principle of the driving method based on the voltage response characteristic described above will be explained. FIGS. 13A, 13C and 13E illustrate waveforms of voltage pulses. FIGS. 13B, 13D and 13F illustrate pulse response characteristics corresponding to the applied voltage pulses illustrated in FIGS. 13A, 13C, and 13E, respectively. FIG. 13A illustrates a voltage pulse having voltages of ±36 volts and a pulse width of several tens of milliseconds (ms). FIG. 13C illustrates a voltage pulse having ON-voltages of ±20 volts, OFF-voltages of ±10 volts and a pulse width of 2 ms. FIG. 13E illustrates a voltage pulse having ON-voltages of ±20 volts, OFF-voltages of ±10 volts and a pulse width of 1 ms. In each of FIGS. 13B, 13D, and 13F, horizontal and vertical axes represent voltage (V) and reflectance or reflection ratio (percent), respectively. The voltage pulse used here is formed by a combination of pulses of positive and negative polarity as a well-known pulse for driving the liquid crystal so that the liquid crystal is prevented from being degraded by ionic polarization, etc.

In the case of a large pulse width illustrated in FIGS. 13A and 13B, if the voltage is raised into a certain range in the planar state as an initial state, the state changes to the focal conic state. With further increasing the voltage, the state returns to the planar state. If the initial state is the focal conic state, the state gradually changes to the planar state as the pulse voltage is further raised.

Pulse voltages inevitably causing the planar state are ±36 volts in the case of a large pulse width regardless of whether the initial state is the planar state or the focal conic state as illustrated in FIG. 13B. Further, a middle voltage between the above voltages causes the planar state and the focal conic state to be mixed so that a halftone display is enabled.

With reference to FIGS. 13C and 13D, will be explained the case of the pulse width of 2 ms. The pulse voltages in the range of ±10 volts do not cause the change in the reflectance when the initial state of the liquid crystal is in the planar state. If the voltage further grows, the reflectance decreases in the mixed state of the planar and focal conic states. Although growing as the voltage grows, the decrease of the reflectance levels off at the voltage beyond the range ±36 volts, which does not change if the initial state is the mixed state of the planar and focal conic states. Thus, when a voltage pulse having a pulse width of 2 milliseconds and pulse voltages of ±20 volts is applied once in an initial state being the planar state, the reflectance decreases to some extent. After the reflectance decreases a little in the mixed state of the planar and focal conic states and if another voltage pulse having a pulse width of 2 milliseconds and pulse voltages of ±20 volts is further applied, the reflectance further decreases. If such a cycle is repeated, the reflectance decreases down to a specific value.

With reference to FIGS. 13E and 13F, the applied voltage pulse of pulse width of 1 millisecond causes the reflectance to decrease similarly as in the case of the pulse width of 2 milliseconds, while the decrease of the reflectance is smaller than that in the case of the pulse width of 2 milliseconds.

As described above, the planar state is caused by an application of a pulse of a pulse width of several tens of milliseconds and 36 volts. Further, the planar state changes to the mixed state of the planar and focal conic states resulting in that the reflectance decreases when a pulse of a pulse width of 2 milliseconds and a dozen to about 20 volts is applied. The decrease of the reflectance presumably relates to accumulated pulse widths.

When the cholesteric liquid crystal is driven according to the dot matrix method, the drive waveform may preferably be an alternating current waveform, as is the case with ordinary liquid crystal, so as to reduce the deterioration in the liquid crystal material. FIG. 14 illustrates the example where the above-described voltage responsivity is used to actually drive the liquid crystal. Namely, FIG. 14 schematically illustrates the state where the letter “F” of the alphabet is being drawn after each of pixels is initialized to the planar state through the application of a voltage of ±36V.

Of selected lines that are illustrated in FIG. 14, each of pixels that are drawn in black corresponds to “select all” and a voltage of about ±20V illustrated in FIG. 14 is applied to each of the pixels. Further, each of pixels holding white image data, the pixels being provided on a selected line, corresponds to “select half” and a voltage of about ±10V illustrated in FIG. 14 is applied to each of the pixels. Since a voltage lower than that applied to the half-selected pixels is applied onto other non-selected lines, the white image data is retained.

As related art, Japanese Laid-open Patent Publication No. 2002-006297 discloses a liquid crystal light modulation element including the cholesteric liquid crystal.

### SUMMARY

According to an aspect of the invention, a laminated type display device includes a plurality of display elements, each of the plurality of the display elements being configured to reflect respective colors, each of the respective colors being different from each other, each of the plurality of the display elements including respective transparent electrodes of which spectral characteristics are different each other.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic cross section of a display element provided in a laminated-type display apparatus according to a first embodiment of the present invention;

FIG. 2 is a diagram illustrating an exemplary configuration of the display apparatus according to the above-described embodiment;

FIG. 3 is a block diagram illustrating the entire configuration of a drive circuit;

FIG. 4 is a diagram illustrating the relationship between the film thickness and transmission spectrum of a transparent electrode, which is observed in a film substrate to which a transparent electrode material is applied;

FIG. 5 is a diagram illustrating an exemplary reflection component of the transparent electrode, which is roughly calculated based on the transmission spectrum illustrated in FIG. 4;

FIG. 6 is a diagram illustrating the relationship between the film thickness and the electrical resistance of the transparent electrode;

FIGS. 7A and 7B are diagrams illustrating exemplary results of simulating the relationship between the electrical resistance of the transparent electrode and a drive waveform distortion (rounding), respectively;

FIGS. 8A to 8c illustrate specific examples of a display apparatus according to an embodiment of the present invention;

FIGS. 9A to 9C are diagrams for comparison of the first embodiment with a first and a second comparison examples;

FIG. 10A is a diagram for illustrating exemplary reflection spectrums that are observed during black display in the first embodiment, and the first and second comparison examples, FIG. 10B is a diagram for illustrating exemplary x, y chromaticities that are observed in the first embodiment, and the first and second exemplary comparisons, and FIG. 10C is a diagram for illustrating exemplary contrasts that are observed in the first embodiment, and the first and second comparison examples;

FIG. 11 is a diagram for illustrating an exemplary configuration of a display apparatus according to a second embodiment of the present invention;

FIGS. 12A and 12B are diagrams illustrating exemplary states of the cholesteric liquid crystal;

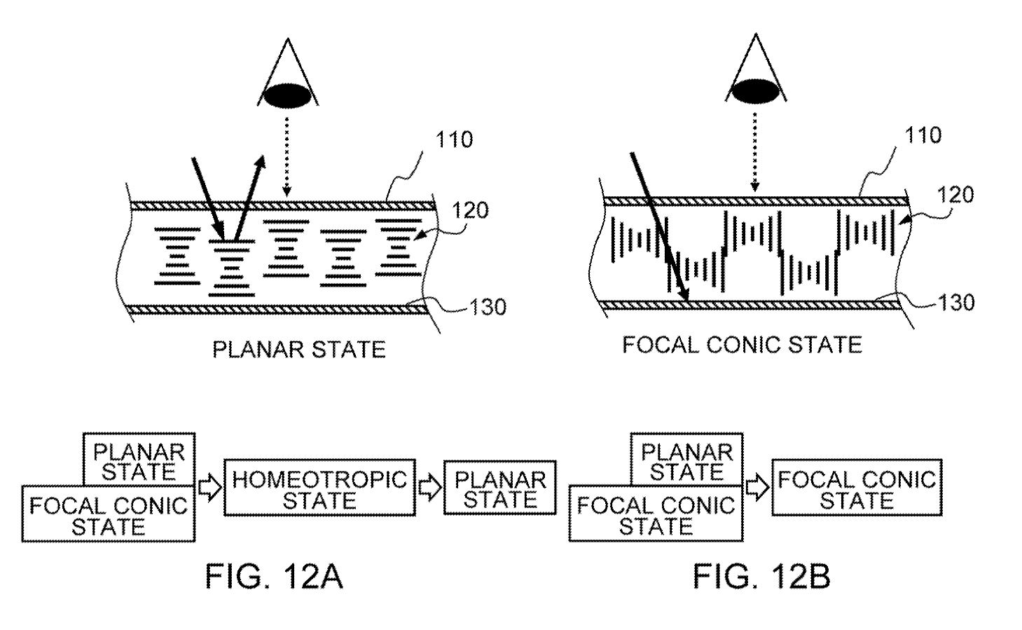

FIG. 13A is a diagram illustrating an exemplary waveform of a voltage pulse, FIG. 13B illustrating exemplary pulse response characteristics, FIG. 13C also is illustrating an exemplary waveform of a voltage pulse, FIG. 13D illustrating exemplary pulse response characteristics, FIG. 13E also is illustrating an exemplary waveform of a voltage pulse, and FIG. 13F illustrating exemplary pulse response characteristics; and

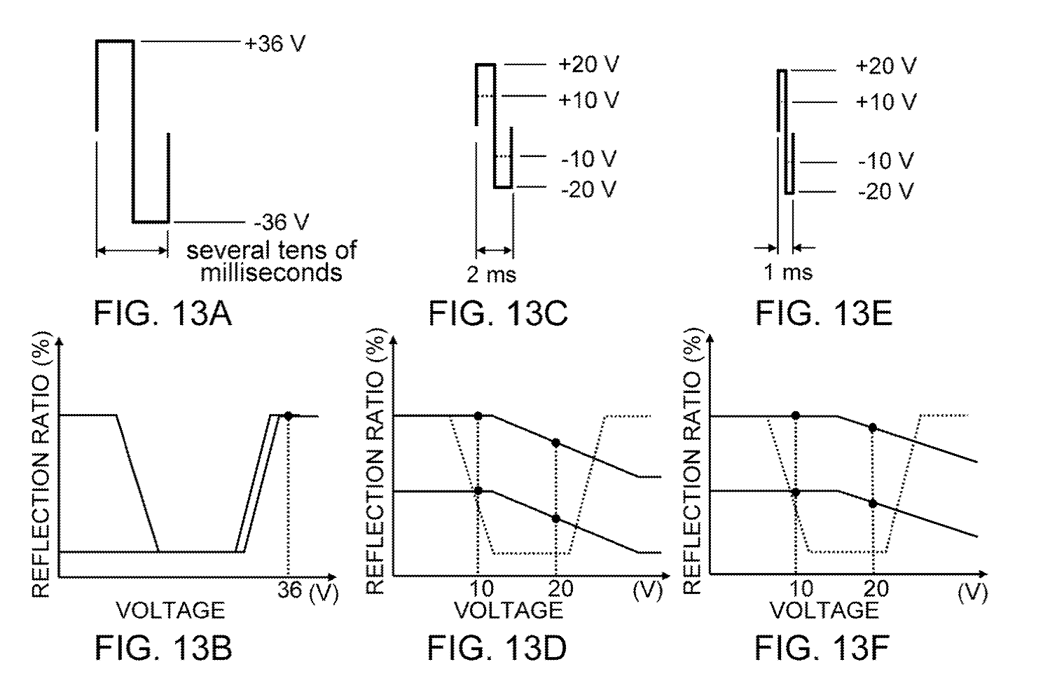

FIG. 14 is illustrating an example where actual driving is performed based on the voltage responsivity.

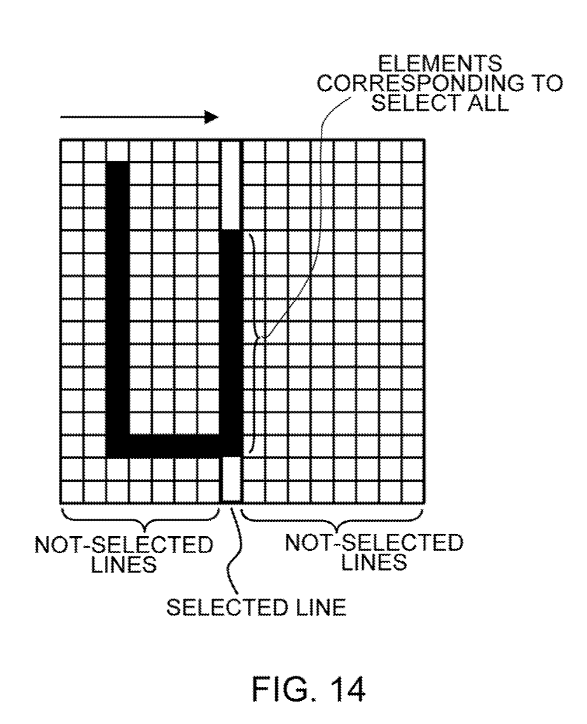

### DESCRIPTION OF EMBODIMENTS

The above-described technologies disclosed in Japanese Laid-open Patent Publication No. 2002-006297, however, single panels having the same electrical resistance and thickness are laminated on one another. In that case, the biased color occurs in the black display. Accordingly, it is preferable to reduce the biased color occurring in the black display of a laminated-type display device.

### First Embodiment

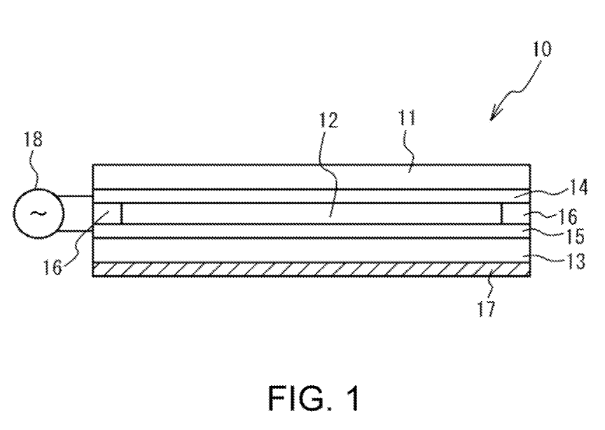

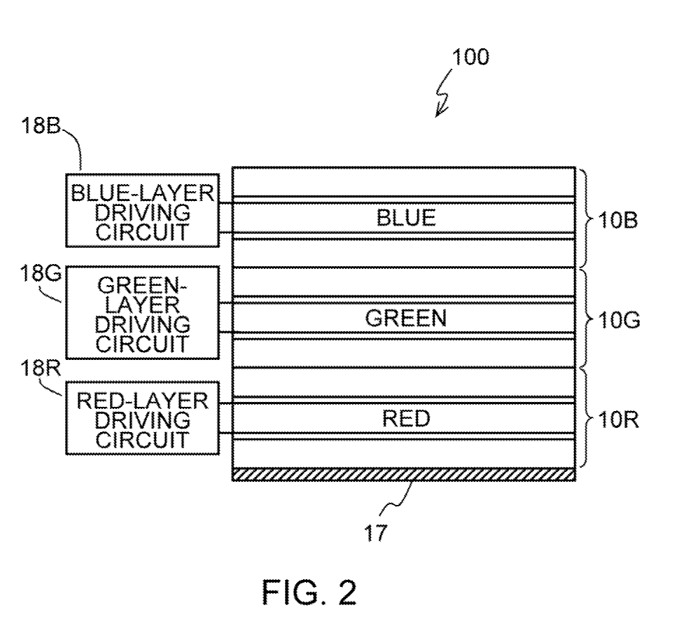

Embodiments will be explained hereafter with reference to the drawings. FIG. 1 is a simplified cross section of a display element 10 included in a laminated-type display device 100 of a first embodiment, which will be found in FIG. 2. As illustrated in FIG. 1, the display element 10 includes an upper substrate 11, an upper electrode 14 provided at the lower side of the upper substrate 11, a lower substrate 13, a lower electrode 15 provided at the upper side of the lower substrate 13, and a sealing material 16. Further, a visible light absorbing layer 17 is provided as necessary below the lower substrate 13 (on an external face) positioned opposite the side of light incidence.

The upper substrate 11 and the lower substrate 13 are arranged in such a way that the electrodes 14 and 15 face each other, and are sealed with the sealing material 16 after a liquid crystal layer 12 is enclosed between the upper substrate 11 and the lower substrate 13. A spacing support may be arranged in the liquid crystal layer 12. A driving circuit 18 applies a voltage pulse signal to the upper electrode 14 and the lower electrode 15 so that voltage is applied to the liquid crystal layer 12. The liquid crystal layer 12 is a cholesteric liquid crystal composition which shows a cholesteric phase. Voltage is applied to the liquid crystal layer 12 so that liquid crystal molecules in the liquid crystal layer 12 are put in the planar state or in the focal conic state. The screen to be displayed is composed with use of these states.

Both the upper substrate 11 and the lower substrate 13 have transparency, however, the lower substrate 13 is allowed to be opaque. The substrates having transparency includes a glass substrate, and film substrates such as PET (polyethylene terephthalate) or PC (polycarbonate) may be used instead of the glass substrate.

The upper electrode 14 and the lower electrode 15 are transparent electrodes. Indium tin oxide (ITO), e.g., is representative of the material for the transparent electrodes. In addition, transparent conductive membrane such as indium zinc oxide (IZO) may be used. Further, in recent years, transparent electrodes including an organic material have been introduced in addition to the transparent electrodes including the above-described inorganic materials.

The upper electrode 14 is formed on the upper substrate 11 by a plurality of upper transparent electrodes each of which is a strip-shape and parallel to one another. The lower electrode 15 is formed on the lower substrate 13 by a plurality of lower transparent electrodes each of which is a strip-shape and parallel to one another. The upper substrate 11 and the lower substrate 13 are arranged in such a way that the upper and lower electrodes cross as viewed in a direction perpendicular to the substrates, and pixels are formed on the crossings.

Electrical insulating thin films are formed on each of the electrodes 14 and 15. If the thin film is thick, driving voltage needs to be high, and it turns difficult to form a driving circuit by using an all-purpose driver for STN-use, etc. In the absence of the thin film, conversely, a leak current increases and causes a problem of a power consumption increase. Incidentally, as a relative permittivity of the thin film is about five and much lower than that of the liquid crystal, the thin film may preferably be about 0.3 μm or less in thickness. Incidentally, the thin film (the electrical insulating thin film) may be implemented by a thin film of SiO₂ or organic membrane such as polyimide resin or acryl resin both of which are known as films for alignment stabilization.

Incidentally, spacers may be provided between the upper substrate 11 and the lower substrate 13 so as to make an inter-substrate gap evenly spaced. A sphere made of resin or inorganic oxide may be used as the spacer. Further, an adhesive spacer superficially coated with thermoplastic resin may be used, as well. A cell gap formed by the spacers may preferably be around 4-6 μm in separation. A cell gap of a separation smaller than that range causes a decrease of the reflectance and a dark display resulting in that high threshold steepness may be barely expected. Meanwhile, although being able to secure high threshold steepness, a cell gap of a separation larger than that range causes driving voltage to be high and makes it difficult to drive the display element by using all-purpose parts.

The cholesteric liquid crystal which forms the liquid crystal layer 12 is formed by mixed nematic liquid crystal to which chiral material is added by 10-40 wt-percent. The addition rate of the chiral material shows a value on the assumption that a total amount of the nematic liquid crystal component and the chiral material corresponds to 100 wt-percent. Various kinds of nematic liquid crystal well known may be used. Nematic liquid crystal is preferably one having permittivity anisotropy Δε in the range 15≦ε≦25 for relative low voltage for driving the liquid crystal layer 12. If the permittivity anisotropy Δε is greater than that range, the liquid crystal layer 12 has small relative resistance, although the voltage itself for driving the liquid crystal layer 12 may be made low. Thus, the display element 10 undesirably consumes more power particularly in high temperature condition. Further, a value of refractive index anisotropy Δn of the cholesteric liquid crystal may preferably be 0.18≦Δε≦0.26. If the refractive index anisotropy Δn is smaller than that range, the reflectance of the liquid crystal layer 12 is rendered low in the planar state. If the reflectance anisotropy Δn is greater than that range, the liquid crystal layer 12 causes great scattering reflection in the focal conic state, and causes higher viscosity and lower speed of response as well.

FIG. 2 illustrates a configuration of the display device 100 according to the embodiment. As illustrated in FIG. 2, the display device 100 has a layered structure of panel element including display elements 10B, 10G, and 10R. The display elements 10B, 10G, and 10R provide blue, green, and red reflective color, respectively. The visible light absorbing layer 17 is provided below the display element 10R.

The three display elements 10B, 10G and 10R are similarly structured as the display element shown in FIG. 1, and have different wavelength characteristics each other. The liquid crystal material, the chiral material and the content by percentage of the chiral material of the display element 10B are chosen in such a way that a central wavelength of the reflection is blue (approximately 480 nm). Those of the display element 10G are chosen in such a way that a central wavelength of the reflection is green (approximately 550 nm). Those of the display element 10R are chosen in such a way that a central wavelength of the reflection is red (approximately 630 nm). The display elements 10B, 10G and 10R are driven by the driving circuits 18B, 18G and 18R for the blue, green and red layers, respectively.

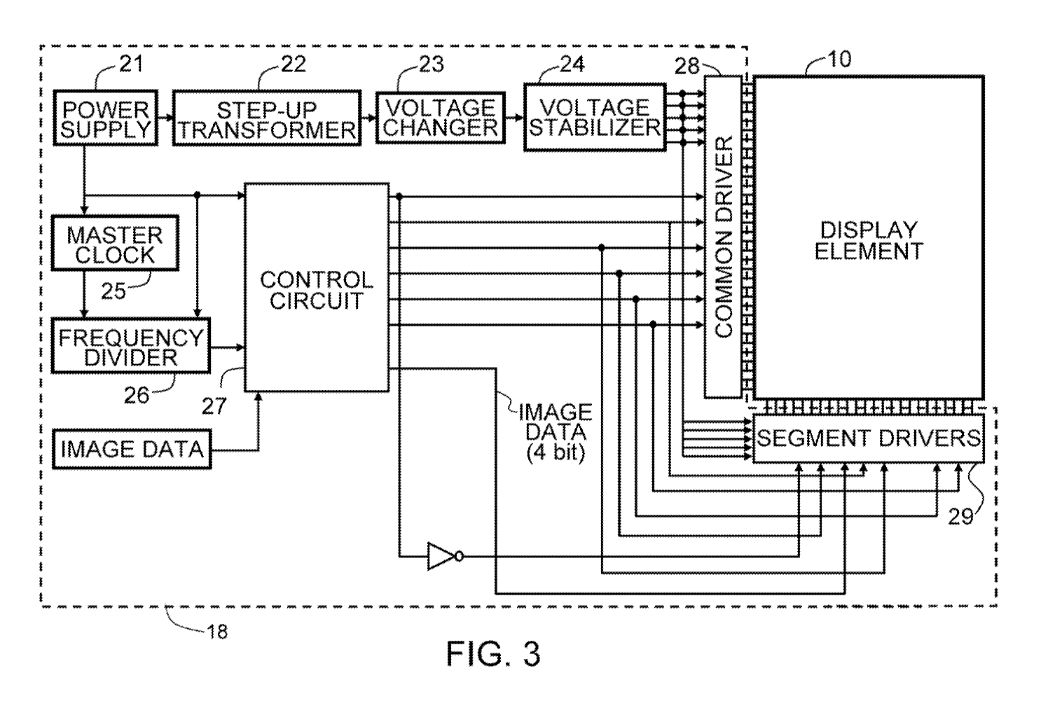

FIG. 3 is a block diagram for illustrating a whole configuration of the driving circuit 18. FIG. 3 illustrates a case in which, e.g., the display element 10 is A4-sized (297 mm by 210 mm) and has 1024×768 pixels in accordance with the XGA specification. The driving circuit 18 includes a power supply 21, a step-up transformer 22, a voltage changer 23, a voltage stabilizer 24, a master-clock generator 25, a frequency divider 26, a control circuit 27, a common driver 28 and a segment driver 29.

The power supply 21 provides voltage of, e.g., 3-5 volts. The step-up transformer 22 steps up the input voltage provided by the power supply 21 to 36-40 volts by using a regulator such as a DC-DC converter. Such type of step-up regulator widely uses an exclusive IC which has a function for adjusting the stepped-up voltage by setting a feedback voltage to the IC. Thus, the regulator may be configured to choose a plurality of voltages produced by resistor-dividing, etc., and to provide a feedback terminal with the chosen voltage, so as to change the stepped-up voltage.

The voltage changer 23 produces various voltages by resistor-dividing, etc. The voltage changer 23 may use an analog switch of high withstand voltage for switching a reset voltage and a gradation writing voltage, and may use a switching circuit simply formed by transistors. The voltage stabilizer 24 may preferably use a voltage follower circuit of an operational amplifier so as to regulate the various voltages supplied by the voltage changer 23. It is preferable to use an operational amplifier having a sufficient characteristic to a capacitive load. Incidentally, a configuration for switching amplifier gains over by changing resistors connected with the operational amplifier is widely known. Thus, the use of this configuration may easily enable a switchover of the voltage provided by the voltage stabilizer 24.

A master-clock generator 25 generates a primary clock (master clock) signal on which operations are based. A frequency divider 26 divides the frequency of the primary clock signal so as to generate various clock signals necessary for operations described later. A control circuit 27 generates a control signal on the basis of the primary clock signal, the various clock signals and image data D, and transmits the control signal to a common driver 28 and a segment driver 29.

The common driver 28 drives 768 scan lines and the segment driver 29 drives 1024 data lines. As pieces of image data provided to respective R (red), G (green), and B (blue), that is RGB, pixels are different, the segment driver 29 drives the respective data lines independently. The common driver 28 drives the R, G, and B lines in common. One of driver ICs to be used for the embodiment is an all-purpose STN driver of a binary output. Various types of driver ICs may be used.

The segment driver 29 is provided with four-bit image data DO-D3 such that a full-color original image is converted into data of 4096 colors, i.e., 16 gradations for each of R (red), G (green), and B (blue) color components, by means of an error diffusion method. It is preferable to use a gradation conversion method which may achieve high display quality, and a blue noise masking method, etc., may be used as well as the error diffusion method.

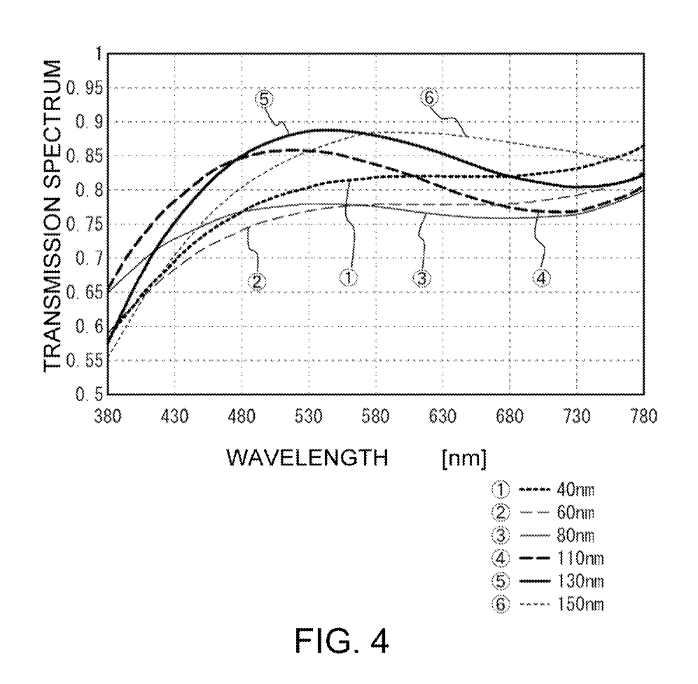

Here, the relationship between the film thickness and the spectral characteristic of the transparent electrode will be described. FIG. 4 illustrates the relationship between the film thickness and the transmission spectrum of the transparent electrode each of which has a film thickness indicated by circled figure. In FIG. 4, the same material is used for each of transparent electrodes. As illustrated in FIG. 4, the transmission spectrum is changed with a change in the film thickness. On the other hand, light which is not allowed to pass through is absorbed and/or reflected by the transparent electrode itself and/or a different member. The absorbed light is mainly the short wavelength-side (blue-side) light. Light which is reflected and visually recognized during the black display is mainly the long wavelength-side (red-side) light.

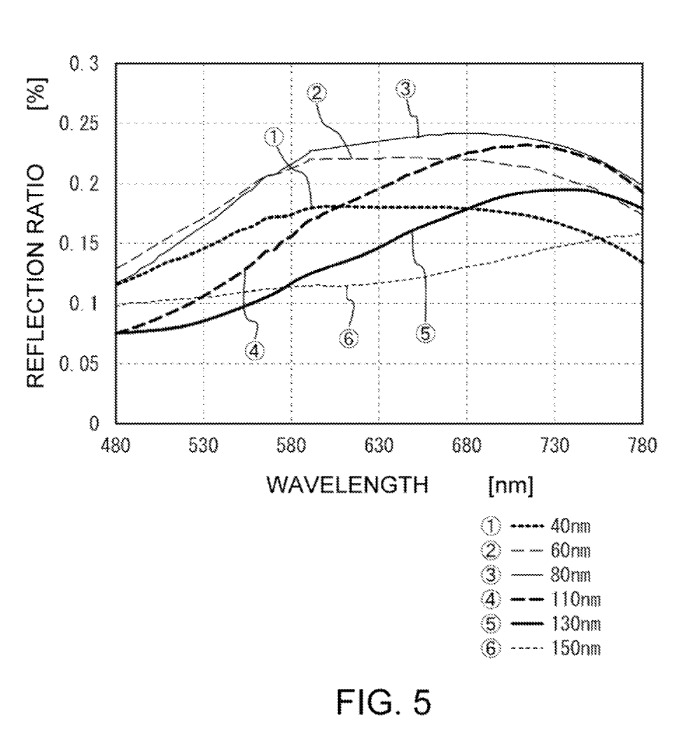

FIG. 5 illustrates an exemplary reflection component of a light reflected by the transparent electrode, which is roughly calculated based on the transmission spectrum illustrated in FIG. 4. Characteristics of the short wavelength-side light are not illustrated in FIG. 5 to make an easy comparison between the middle wavelength to long wavelength-side lights. Referring to FIG. 5, when the value of the film thickness is 40 to 60 nm (nanometer), the reflection component has its peak in the neighborhood of 580 nm. Accordingly, the above-described reflection component has a greenish hue. Next, when the value of the film thickness is 80 to 130 nm, the peak of the reflection component is shifted to the neighborhood of 680 nm. Therefore, the hue of the above-described reflection component is shifted to the red color-side. When the value of the film thickness is further increased to 150 nm, the long wavelength-side peak disappears. Thus, each of the film thickness of the transparent electrode and the peak wavelength of the reflection component exhibits periodicity and the peak wavelength is shifted repeatedly with an increase in the film thickness.

Each of the reflection components that are illustrated in FIGS. 4 and 5 is an exemplary reflection component attained in the case where a single layer of the transparent electrode is provided. If a three-layer laminated panel is provided, the transparent electrodes are laminated on one another in six layers at the maximum. Therefore, the hue reflected by the transparent electrodes becomes significant.

In general, the film thickness of each of transparent electrodes is selected so that the transmittance reaches its peak in a green area where the highest visibility is obtained. Consequently, the brightness of display is not spoiled. In that case, however, the hue of the reflection component is shifted toward the red color-side. Therefore, the reddish black phenomenon occurring in the black display becomes noticeable.

In the first embodiment, therefore, the film thickness of each of the transparent electrodes is selected so that the spectral characteristics of the transparent electrodes of at least two of the display elements 10R, 10G, and 10B become different from each other. More specifically, it is arranged that there is a difference between the peak wavelengths of the reflection spectrums of the transparent electrodes of at least two of the above-described display elements. In that case, the peak wavelength of the reflection spectrum is diffused. Consequently, the hues of the reflection spectrums become different from each other. As a result, the biased color occurring in the black display is reduced.

More specifically, the film thickness of each of the upper electrode 14 and the lower electrode 15 of any of the display elements is set to about 40 to 60 nm, and that of each of the upper electrode 14 and the lower electrode 15 of a different display element is set to about 110 to 130 nm. Consequently, the peak wavelengths of the reflection spectrums become different from each other.

For attaining an appropriate achromatic color through a further reduction in the biased color, the above-described difference between the peak wavelengths of the reflection spectrums is preferably at least 50 nm in the visible light area. It is more preferable that the above-described difference be at least 100 nm. When the above-described difference is less than 50 nm, the hues become identical and/or similar to each other. In that case, most of the effect of reducing the biased color is lost.

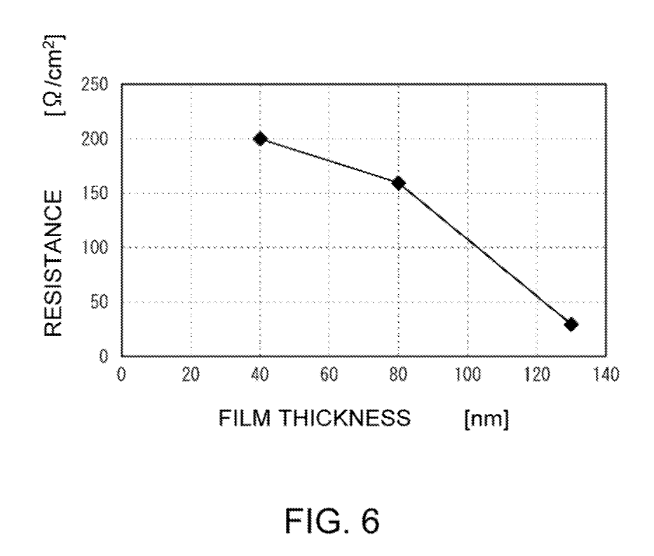

When the same material is used for the transparent electrodes, the electrical resistance of each of the transparent electrodes is changed by changing the film thicknesses of the transparent electrodes. There is a tendency that the waveform rounding is increased with an increase in the electrical resistance of the transparent electrode. Hereinafter, the relationship between the film thickness and the electrical resistance of the transparent electrode will be described with reference to FIG. 6. Referring to FIG. 6, the electrical resistance is decreased with an increase in the film thickness. Although the drive waveform rounding is decreased with a decrease in the electrical resistance, the cost is increased. On the other hand, although the cost is decreased with a decrease in the film thickness and an increase in the electrical resistance, the drive waveform rounding is increased.

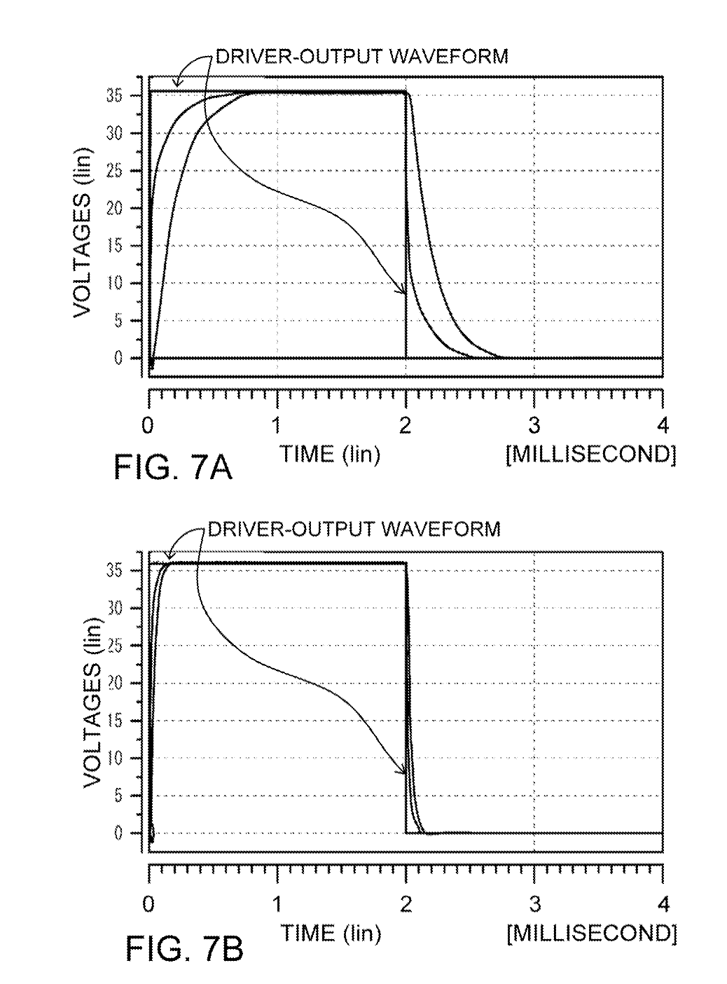

Each of FIGS. 7A and 7B illustrates an exemplary result of simulating the relationship between the electrical resistance of the transparent electrode and the drive waveform rounding. FIG. 7A illustrates a drive waveform rounding occurring in a transparent electrode having a sheet resistance of 200 Ω/cm². FIG. 7B illustrates a drive waveform rounding occurring in a transparent electrode having a sheet resistance of 30 Ω/cm².

In each of FIGS. 7A and 7B, the value of the drive waveform is equivalent to a CR time constant, and an input waveform is assumed as an ideal rectangular pulse. In the transparent electrode having the sheet resistance of 200 Ω/cm², both the rise and the fall of the pulse are larger than those observed in the transparent electrode having the sheet resistance of 30 Ω/cm². The effect of the waveform rounding on the response characteristics of the liquid crystal is increased with distance from the drive circuit and/or a decrease in the width of the drive pulse. As for a pixel provided at a place far from the drive circuit, the value of electrical resistance from the drive circuit to the pixel is increased so that the CR time constant is increased. As a result, the waveform rounding becomes significant and the response of the liquid crystal slows down. Therefore, the contrast of the pixel far from the drive circuit becomes lower than that of a pixel provided near the drive circuit.

In the present embodiment, therefore, the value of electrical resistance of the transparent electrode of a display element provided for a color with high visibility is determined to be low, and that of electrical resistance of the transparent electrode of a display element provided for a color with low visibility is determined to be high.

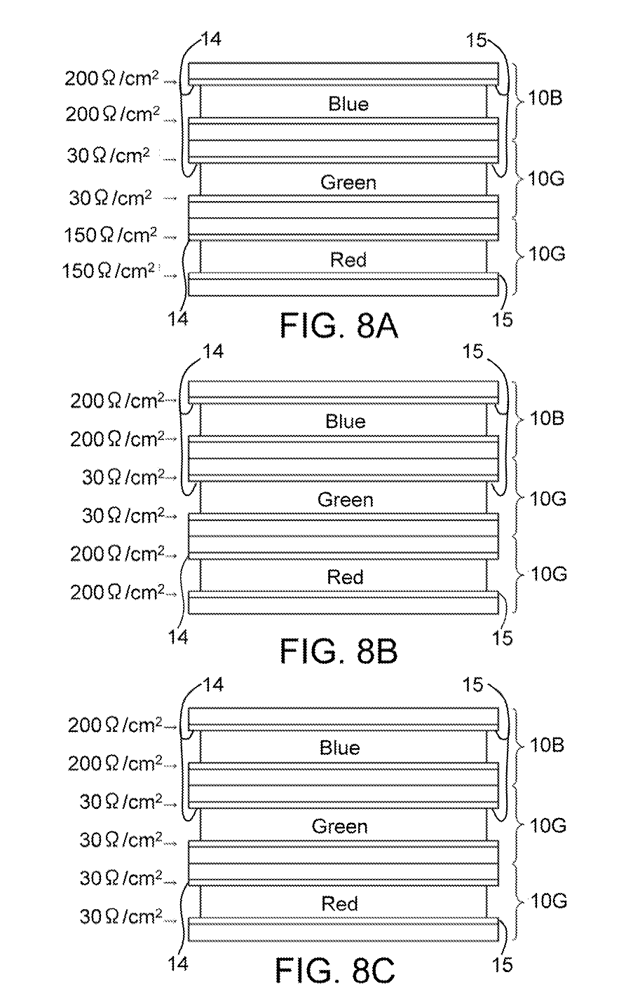

FIGS. 8A to 8C each illustrates a specific example of the display device 100 according to the above-described embodiment. Since the visibility of the green (G) color is higher than those of the red (R) color and the blue (B) color, the display irregularities occurring due to the waveform rounding are noticeable in the display element 10G for displaying green image. On the other hand, since the visibility of each of the red (R) color and the blue (B) color is lower than that of the green (G) color, the display irregularities occurring due to the waveform rounding are less noticeable in each of the display elements 10R and 10B.

Therefore, referring to FIGS. 8A to 8C, the electrical resistance of each of the upper electrode 14 and the lower electrode 15 that are provided in the display element 10G is determined to be lower than that of each of the upper electrode 14 and the lower electrode 15 that are provided in each of the display elements 10B and 10R. For example, the electrical resistances of the transparent electrodes are determined so that the expressions including the electrical resistance of the transparent electrode of the blue layer>the electrical resistance of the transparent electrode of the red layer>the electrical resistance of the transparent electrode of the green layer (FIG. 8A), the blue layer the red layer>the green layer, or the blue layer>the red layer the green layer hold, where “the electrical resistance of the transparent electrode” in the latter expression is omitted for clarity of description. FIG. 8B illustrates the case of “the blue layer=the red layer>the green layer” and FIG. 8C illustrates the case of “the blue layer>the red layer=the green layer.” Here, “the blue layer”, for example, is the electrical resistance of the electrode(s) provided for the blue layer.

As an example, the sheet resistance of each of the upper electrode 14 and the lower electrode 15 of the display element 10G is determined to be 30 Ω/cm², and that of each of the upper electrode 14 and the lower electrode 15 that are provided in each of the display elements 10B and 10R is determined to be 200 Ω/cm². Further, the upper electrode 14 and the lower electrode 15 that are provided in each of the display elements 10R, 10G, and 10B have the same area. Therefore, in this specification, the electrical resistance ratio of the transparent electrode having the sheet resistance of 30 Ω/cm² to that having the sheet resistance of 200 Ω/cm² is 30:200.

Further, for making the spectral characteristics of the display elements different from one another, the film thickness of each of the upper electrode 14 and the lower electrode 15 of the display element 10G is determined to be about 110 to 130 nm, and that of each of the upper electrode 14 and the lower electrode 15 of each of the display elements 10B and 10R is determined to be about 40 to 60 nm. In that case, it becomes possible to make the wavelength peaks of the reflection spectrums different from one another as an explanation using FIG. 5.

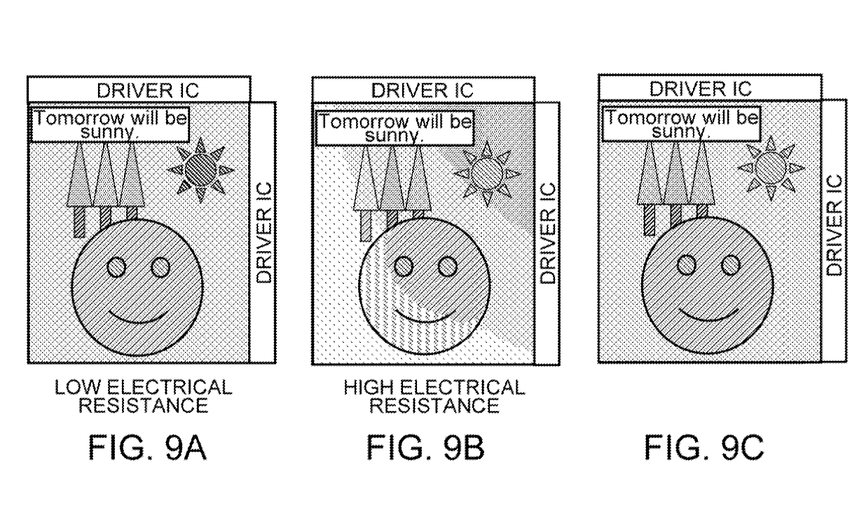

Each of FIGS. 9A, 9B, and 9C is provided to illustrate an exemplary result of comparing the first embodiment to first and second comparison examples. FIG. 9A illustrates a result of displaying data through a display device according to the first comparison example. FIG. 9B illustrates a result of displaying data through a display device according to the second comparison example. FIG. 9C illustrates a result of display data through the display device according to the above-described embodiment.

In the display device according to the first comparison example, the sheet resistances of the upper electrode and the lower electrode of the three display elements of the three layer display element are standardized at 30 Ω/cm². Further, the film thicknesses of the upper electrode and the lower electrode of the three display elements of the three layer display elements are standardized at about 110 to 130 nm. In the display device according to the second comparison example, the sheet resistances of the upper electrode and the lower electrode of the three display elements of the three layer display element are standardized at 200 Ω/cm². Further, the film thicknesses of the upper electrode and the lower electrode of the three display elements of the three layer display element are standardized at about 40 to 60 nm.

Referring to FIG. 9A, the waveform rounding is decreased with a decrease in the electrical resistance of each of the transparent electrodes so that the display irregularities ascribable to the distance from the drive circuit hardly occur. However, the film thicknesses of the transparent electrodes remain constant and there are no differences between the spectral characteristics of the display elements, the biased color such as the reddish black phenomenon occurs in the black display. Referring to FIG. 9B, the waveform rounding is increased with an increase in the electrical resistance of each of the transparent electrodes so that the display irregularities ascribable to the distance from the drive circuit occur. Further, since the film thicknesses of the transparent electrodes remain constant and there are no differences between the spectral characteristics of the display elements, the biased color such as the greenish black phenomenon occurs in the black display.

On the contrary, in the above-described embodiment, even though the value of the waveform rounding becomes relatively large due to a high resistance in each of the display elements 10B and 10R, the display irregularities become less noticeable due to the low visibility of each of the blue color and the red color. Further, in the display element 10G, the waveform rounding is decreased due to the low resistance so that the display irregularities become less noticeable. Further, since the spectral characteristic of each of the transparent electrodes that are provided in the display element 10G is different from that of each of the transparent electrodes that are provided in each of the display elements 10B and 10R, the biased color occurring in the black display is reduced. Thus, the above-described embodiment allows for reducing a trade-off between the display irregularities and the biased color. Further, the cost becomes lower than in the case where the resistance of each of the transparent electrodes is decreased.

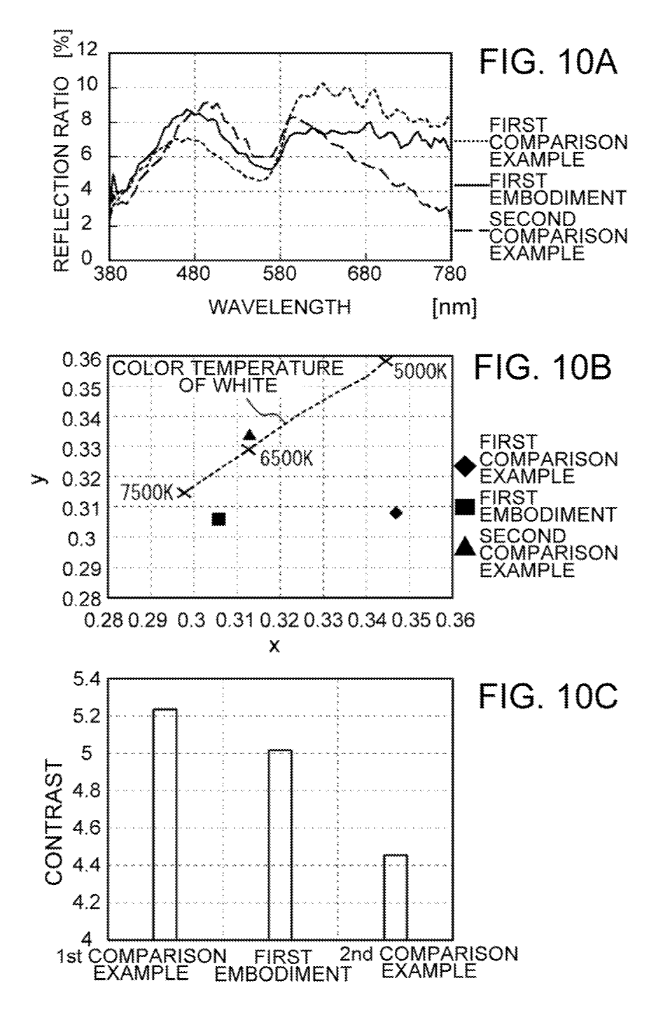

FIG. 10A illustrates exemplary reflection spectrums that are observed during the black display in the first embodiment, and the first and second comparison examples. FIG. 10B illustrates exemplary x, y chromaticities that are observed in the first embodiment, and the first and second comparison examples. FIG. 10C illustrates exemplary contrasts that are observed in the first embodiment, and the first and second comparison examples. In FIG. 10A, the horizontal axis indicates the wavelength of the reflection spectrum and the vertical axis indicates the reflectance. In FIG. 10B, the horizontal axis indicates the x chromaticity and the vertical axis indicates the y chromaticity. Here, the display color approaches a red color with an increase in the x chromaticity and approaches a blue color with a decrease in the x chromaticity. Further, the display color approaches a green color with an increase in the y chromaticity and approaches a purple color with a decrease in the y chromaticity. In FIG. 10C, the vertical axis indicates the contrast.

As illustrated in FIG. 10A, the reflection spectrums change in accordance with the individual configurations. The first comparison example indicates that the reddish black phenomenon is noticeable due to a high reflectance observed on the long wavelength-side. The second comparison example indicates that the greenish black phenomenon is noticeable due to a high reflectance observed on the short to middle wavelength-side and a low reflectance observed on the long wavelength-side. Compared to the above-described first and second comparison examples, the reflectance is leveled in the first embodiment. Consequently, the biased color occurring in the black display is reduced in the first embodiment.

FIG. 10B illustrates the color temperature of a white color. The display color approaches a bluish color with an increase in the color temperature. Usually, it is preferable that the color temperature of a white color be at least 6500 K. Therefore, the white color used in practice is designed to have an xy chromaticity of at least 6500 K. Here, it is preferable that the xy chromaticity be not far from the locus of the color temperature of the white color between the white and black colors. According to the display element of the first comparison example, the xy chromaticity is far from the locus of the color temperature of the white color. According to the display element according to the second comparison example, the color temperature is low. In comparison with the above-described results, in the display element according to the first embodiment, the color temperature is high and the xy chromaticity approaches the locus of the color temperature of the white color. Thus, the display element according to the above-described embodiment may achieve appropriate black color-image data.

FIG. 10C illustrates that the contrast is reduced in the second comparison example and is maintained at a high level in each of the first comparison example and the first embodiment.

In the first embodiment, the spectral characteristics of at least two of the display elements are made different from each other to reduce the biased color occurring in the black display. Further, the electrical resistance of the transparent electrode of the display element for display of high visibility color is determined to be low and that of the transparent electrode of the display element for display of low visibility color is determined to be high so that the display irregularities are reduced.

The drive pulse becomes increasingly fine with an increase in the gradation number, and the effect of the waveform rounding is increased. Therefore, the effect of the waveform rounding may be reduced by decreasing the gradation number of the display element 10B and increasing the drive pulse width. Since the visibility of a blue color is low, the reduction in the gradation number is perceived with difficulty. Therefore, for example, when the gradation number of the display element 10G is 64, the gradation number of the display element 10R with low visibility may be determined to be 32, and that of the display element 10B with visibility lower than those of the display elements 10G and 10R may be determined to be 16. Further, the display gradation numbers may be determined as the following expressions.

Nb<Nr<Ng, Nb≦Nr<Ng, or Nb<Nr≦Ng,

where Nb is the display gradation number of the display element for display blue color, Nr is that of the display element for display red color, and Ng is that of the display element for display green color.

Further, the absolute value of the electrical resistance of the transparent electrode is correlated with the panel size. Since the capacitance of the liquid crystal layer is increased with an increase in the panel size, it is preferable that the electrical resistance of the transparent electrode be reduced to ensure a small CR time constant. On the other hand, the capacitance of the liquid crystal layer is decreased with a decrease in the panel size. Therefore, the electrical resistance of the transparent electrode may have a relatively high value. For example, the range of practical use of the transparent electrode corresponds to a sheet resistance of 10 to 1000 Ω/cm². Therefore, it is preferable to use appropriate transparent electrodes falling within the above-described range in combination.

### Second Embodiment

In the first embodiment, the electrical resistance of the upper electrode layer is equivalent to that of the lower electrode layer in each of the display elements. However, without being limited to the above-described embodiment, the electrical resistance of the upper electrode layer may be different from that of the lower electrode layer in each of the display elements.

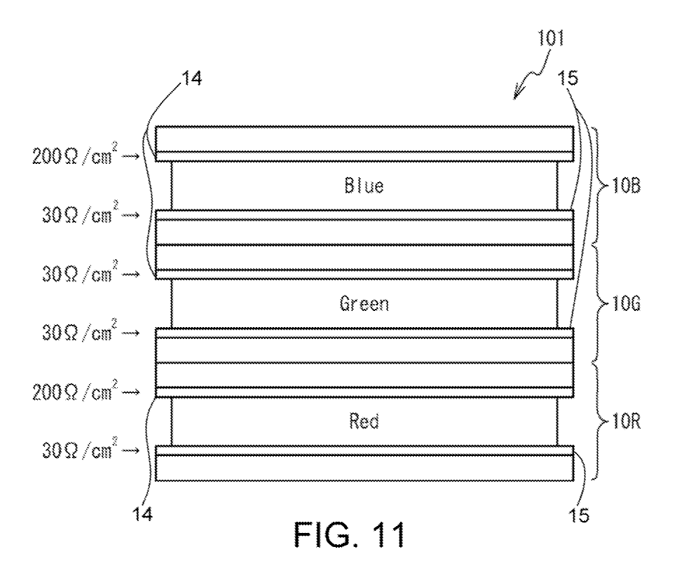

FIG. 11 illustrates an exemplary configuration of a display device 101 according to a second embodiment of the present invention. The difference between the display device 101 and the display device 100 illustrated in FIG. 2 is the electrical resistance value of each of the upper electrode and the lower electrode that are provided in each of the display elements. In the display element 10B of the second embodiment, the sheet resistance of the upper electrode 14 is determined to be 200 Ω/cm², and the film thickness is determined to be 40 to 60 nm, and the sheet resistance of the lower electrode 15 is determined to be 30 Ω/cm², and the film thickness is determined to be 110 to 130 nm. In the display element 10R, the sheet resistance of the upper electrode 14 is determined to be 200 Ω/cm², and the film thickness is determined to be 40 to 60 nm, and the sheet resistance of the lower electrode 15 is determined to be 30 Ω/cm², and the film thickness is determined to be 110 to 130 nm. In the display element 10G, the sheet resistance of each of the upper electrode 14 and the lower electrode 15 is determined to be 30 Ω/cm², and the film thickness is determined to be 110 to 130 nm.

In that case, the display element 10G includes the transparent electrodes having the spectral characteristic different from those of the transparent electrodes that are provided in each of the display elements 10B and 10R. Consequently, it becomes possible to reduce the biased color occurring in the black display. Further, even though the waveform rounding becomes relatively high due to the high resistance in each of the display elements 10B and 10R, the display irregularities become less noticeable due to the low visibility of a blue color and a red color. Further, in the display element 10G, the waveform rounding is decreased due to the low resistance so that the display irregularities are reduced. Thus, the above-described embodiment allows for reducing a trade-off between the display irregularities and the biased color. Further, the cost becomes lower than in the case where the resistance of each of the transparent electrodes is decreased.

Although the three-layer structure of RGB colors has been described in each of the above-described embodiments, the present invention can be used for a different laminated structure including, for example, a two-layer structure of blue (B) and yellow (Y) colors without being limited to the above-described embodiments. In that case, the biased color in black displaying may be reduced because the spectral characteristics of the transparent electrodes that are provided in at least two of the display elements including the laminated structure are different from one another. Further, the electrical resistance of the transparent electrode of a display element provided for a color with high visibility (yellow) is determined to be low and that of the transparent electrode of a display element provided for a color with low visibility (blue) is determined to be high, so that the display irregularities can be reduced.

Further, in each of the above-described embodiments, the film thickness of each of the transparent electrodes is changed to change the peak wavelength of the reflection spectrum. Without being limited to the above-described embodiments, however, the peak wavelength of the reflection spectrum can be changed by selecting the type of the transparent electrode, such as a material with a refractive index which is significantly different from those of the above-described transparent electrodes.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A laminated type display device comprising:
a plurality of display elements, each of the plurality of the display elements being configured to reflect respective colors, each of the respective colors being different from each other, each of the plurality of the display elements including respective transparent electrodes of which spectral characteristics are different each other.

2. The laminated type display device according to claim 1, wherein respective transparent electrodes have respective thicknesses which are different each other.

3. The laminated type display device according to claim 1, wherein a first difference between the spectral characteristics corresponds to a second difference between wavelengths associated with respective peaks in reflection spectrums from the respective transparent electrodes, the second difference being equal to or more than 50 nanometers.

4. The laminated type display device according to claim 2, wherein a first difference between the spectral characteristics corresponds to a second difference between wavelengths in associated with respective peaks in reflection spectrums from the respective transparent electrodes, the second difference being equal to or more than 50 nanometers.

5. The laminated type display device according to claim 1, wherein the transparent electrodes have respective electrical resistances of which values are different each other.

6. The laminated type display device according to claim 2, wherein the transparent electrodes, of which the spectral characteristics are different each other, have respective electrical resistances of which values are different each other.

7. The laminated type display device according to claim 3, wherein the transparent electrodes, of which the spectral characteristics are different each other, have respective electrical resistances of which values are different each other.

8. The laminated type display device according to claim 4, wherein the transparent electrodes, of which the spectral characteristics are different each other, have respective electrical resistances of which values are different each other.

9. The laminated type display device according to claim 5, wherein a transparent electrode formed in the display element for display of first visibility has a first electrical resistance value lower than a second electrical resistance value of a transparent electrode formed in the display element for display of second visibility, the first visibility being higher than the second visibility.

10. The laminated type display device according to claim 6, wherein a transparent electrode formed in the display element for display of first visibility has a first electrical resistance value lower than a second electrical resistance value of a transparent electrode formed in the display element for display of second visibility, the first visibility being higher than the second visibility.

11. The laminated type display device according to claim 7, wherein a transparent electrode formed in the display element for display of first visibility has a first electrical resistance value lower than a second electrical resistance value of a transparent electrode formed in the display element for display of second visibility, the first visibility being higher than the second visibility.

12. The laminated type display device according to claim 8, wherein a transparent electrode formed in the display element for display of first visibility has a first electrical resistance value lower than a second electrical resistance value of a transparent electrode formed in the display element for display of second visibility, the first visibility being higher than the second visibility.

13. The laminated type display device according to claim 5, wherein the plurality of the display elements include three display elements for displaying blue color, red color, and green color respectively and electrical resistance value of transparent electrode formed in each of the three display elements satisfies following relationship,
Rg<Rr<Rb, Rg<Rr≦Rb, or Rg≦Rr<Rb,
where Rg is an electrical resistance value of the transparent electrode formed in one of the three display elements for displaying the green color, Rr is an electrical resistance value of the transparent electrode formed in one of the three display elements for displaying the red color, and Rb is an electrical resistance of the transparent electrode formed in one of the three display elements for displaying the blue color.

14. The laminated type display device according to claim 9, wherein the plurality of the display elements include three display elements for displaying blue color, red color, and green color respectively and electrical resistance value of transparent electrode formed in each of the three display elements satisfies following relationship,
Rg<Rr<Rb, Rg<Rr≦Rb, or Rg≦Rr<Rb,
where Rg is an electrical resistance value of the transparent electrode formed in one of the three display elements for displaying the green color, Rr is an electrical resistance value of the transparent electrode formed in one of the three display elements for displaying the red color, and Rb is an electrical resistance of the transparent electrode formed in one of the three display elements for displaying the blue color.

15. The laminated type display device according to claim 5, wherein a display element including the transparent electrode of a first electrical resistance value is configured to display an image of a gradation number less than a gradation number in an image provided by the other display element including the transparent electrode of a second electrical resistance value, the first electrical resistance value being higher than the second electrical resistance value.

16. The laminated type display device according to claim 9, wherein a display element including the transparent electrode of a first electrical resistance value is configured to display an image of a gradation number less than a gradation number in an image provided by the other display element including the transparent electrode of a second electrical resistance value, the first electrical resistance value being higher than the second electrical resistance value.

17. The laminated type display device according to claim 15, wherein the plurality of the display elements include three display elements for displaying blue color, red color, and green color respectively and each of the gradation numbers corresponding to the respective display elements satisfies a following relationship,
Nb<Nr<Ng, Nb≦Nr<Ng, or Nb<Nr≦Ng,
where Nb is the gradation number in an image displayed by the display element for displaying blue color, Nr is the gradation number in an image displayed by the display element for displaying red color, and Ng is the gradation number in an image displayed by the display element for displaying green color.

18. The laminated type display device according to claim 16, wherein the plurality of the display elements include three display elements for displaying blue color, red color, and green color respectively and each of the gradation numbers corresponding to the respective display elements satisfies a following relationship,
Nb<Nr<Ng, Nb≦Nr<Ng, or Nb<Nr≦Ng,
where Nb is the gradation number in an image displayed by the display element for displaying blue color, Nr is the gradation number in an image displayed by the display element for displaying red color, and Ng is the gradation number in an image displayed by the display element for displaying green color.

19. The laminated type display device according to claim 1, wherein each of the plurality of the display elements includes a liquid crystal layer containing a cholesteric liquid crystal.

20. A laminated type display device comprising:
a plurality of display elements, at least one of the plurality of the display elements being configured to reflect respective colors, each of the plurality of the display elements including respective transparent electrodes, the transparent electrodes of the one of the plurality of display elements having spectral characteristic different from the other.
